(19) United States
(12) Patent Application Publication
(10) Pub. No.: US 2018/0274819 A1
(43) Pub. Date: Sep. 27, 2018

(54) CALIBRATION METHOD FOR HELIOSTATS

(71) Applicants: FUNDACIÓN CENER-CIEMAT, Sarriguren (navarra) (ES); FUNDACIÓN TEKNIKER, Eibar (guipuzcoa) (ES)

(72) Inventors: Marcelino SÁNCHEZ GONZÁLEZ, Madrid (ES); Aitor OLARRA URBERUAGA, Guipuzcoa (ES); Cristóbal VILLASANTE CORREDOIRA, Guipuzcoa (ES); David OLASOLO DON, Guipuzcoa (ES); Michael BURISCH, Navarra (ES)

(73) Assignees: FUNDACIÓN CENER-CIEMAT, Sarriguren (navarra) (ES); FUNDACIÓN TEKNIKER, Eibar (guipuzcoa) (ES)

(21) Appl. No.: 15/763,941

(22) PCT Filed: Sep. 28, 2016
(86) PCT No.: PCT/ES2016/070681

§ 371 Date: Mar. 28, 2018

(30) Foreign Application Priority Data
Oct. 2, 2015 (ES) 201531419

(51) Int. Cl. F24S 50/20; F24S 23/77

(52) U.S. Cl. CPC F24S 50/20; F24S 2050/25; F24S 23/77

(57) ABSTRACT

Calibration method for heliostats that comprises carrying out at least a search to visualize at least a reference by means of an artificial vision device arranged in a fixed manner to each of the heliostats to be calibrated; recognizing the reference searched; carrying out a capture of the reference for each of the searches, the capture comprising a taking of an image visualized by the artificial vision device in which the reference appears and a reading of the value of the sensors; collecting and storing data of the taking and the reading; comparing value of sensors of the capture with the value of the sensors according to a kinematic relation that is in effect; stablishing an error for each of the captures; and determining a new kinematic relation.

### TECHNICAL FIELD

The present invention relates to the electrical energy generation sector by capturing solar energy through solar receivers, proposing a calibration method for heliostats that allows sunlight to be accurately guided to a solar receiver during the hours of sunshine.

### STATE OF THE ART

Operation of central receiver solar thermal power plants is highly influenced by efficiency of heliostat fields. The efficiency of the heliostat fields depends largely on the capacity of heliostats to reflect sunlight to a solar receiver during hours of sunshine.

There exists a wide variety of solutions to fulfill the functional requirements to correctly orientate the heliostats. All of the heliostats comprise actuators such as rotary motors and linear actuators on one hand and transmission systems on the other hand. The transmission systems are mechanisms comprising components such as belts, chains, gearboxes, structural components, linkages, etc.

The heliostats comprise control means that establish desired set-points of the actuators (angular position, linear displacements, etc.) in order to adequately reflect the sunlight towards the corresponding solar receiver at any time. In order to do it, the control means must relate position of the actuators and orientation of the heliostats. This relation is defined as kinematic relation and can be stablished by methods that employ equations that represent kinematic chains, implement tables that relate the position of the actuators and the orientation of the heliostats, etc. Upon the heliostats being installed an initial kinematic relation is stablished in the control means according to design of the heliostats and their position in the solar field.

Different type of problems can change said initial kinematic relation generating an incorrect orientation of the heliostats, this is generating that central normal vectors of reflective surfaces of the heliostats do not focus or point to a desired direction, such that the sunlight is not adequately reflected towards the solar receivers during hours of sunshine. Some of these problems are consequence of imprecise fabrication, mounting and installation, unwanted dirt in parts such as gears or joints, impacts, the ground in which the heliostats are located sinks, storms, etc.

Some known heliostats comprise two axes of rotation according to an azimuth or vertical axis and an elevation or horizontal axis, some other of the known heliostats are of the type commonly named “pitch-roll”, some others are of the type commonly named “target alligned”, and some other of the known heliostats are based on parallel kinematic configurations.

At present different calibration methods are known in order to correct said incorrect orientations of the heliostats. Some of these well-known methods require to carry out a manual calibration of the heliostats, one by one, by at least one operator. These methods are not efficient and are best fitted to the heliostat fields with a reduced number of heliostats.

Other known methods require the use of expensive vision devices because in these methods it is necessary to employ the vision devices which can receive several reflections of the sunlight from some of the heliostats at the same time without being damaged. In some cases, the vision devices additionally require the use of some filters in order to directly focus the sun, which have the disadvantage of not allowing to observe any other object than the sun.

Methods are also known in which both the vision devices and references used for the calibration of the heliostats are arranged on high posts apart from the heliostats. These conditions mean that the vision devices must be prepared to resist adverse weather conditions, such as rain and snow, in addition to the fact that these posts generate shadows that can interfere with a correct identification of the references depending on the calibration method employed.

Conventional calibration methods that require a simultaneous observation of the sun and the solar receiver by the vision devices, one of this being known by US2009/249787A1, have another added disadvantage. This disadvantage is a need to use the vision devices with special lenses of high cost to optimally cover a wide field of vision or a limitation of carrying out the calibration only when the sun and the receiver are close to their alignment with respect to the position of the corresponding vision devices.

Additionally, some of the conventional calibration methods do not allow several heliostats to be calibrated simultaneously. This fact supposes a clear undesired disadvantage in fields in which there are tens of thousands of the heliostats due to these methods entail too much calibration time.

Furthermore, the conventional calibration methods do not offer an automatic and simultaneous calibration of all the heliostats that maximizes the efficiency of the heliostat fields.

### OBJECT OF THE INVENTION

A calibration method for heliostats comprising a reflective element and having actuators, sensors defining position of the actuators and a kinematic relation that is in effect for the heliostats. The method comprises the steps of:
carrying out at least a search to visualize at least a reference with a known location by means of an artificial vision device arranged in a fixed manner to each of the heliostats to be calibrated, such that the artificial vision devices are displaced together with the reflective elements and in a same way;
recognizing the reference searched;
carrying out a capture of the reference for each of the searches, the capture comprising a taking of an image visualized by the artificial vision device in which the reference appears and a reading of the value of the sensors;
collecting and storing data of the taking and the reading;
comparing the value of the sensors of the capture with the value of the sensors according to the kinematic relation that is in effect;
stablishing an error for each of the captures according to differences between the value of the sensors of the capture and the value of the sensors according to the kinematic relation that is in effect; and
determining a new kinematic relation that minimises the errors.

The artificial vision devices are arranged at back face of the reflective element, at front face of the reflective element, between the back face and the front face of the reflective element or at a lateral side of the reflective element.

The references comprise identifying characteristics for being visualized, recognized and captured unequivocally. The references are natural or artificial, and/or mobile or stationary. The location of the references is determined according to a pixel contained in a shape fitted along outer contour of the identifying characteristics.

By means of a further artificial vision device with a precisely known location reflection of one of the references is visualized in the reflective element of at least one of the heliostats, and a bisector between a vector from the further artificial vision device to the reflective element and a vector from the reference reflected to the reflective element is determined. The method comprises stablishing a relation between the bisector and focusing direction of the artificial vision devices.

The searches of the references are carried out by changing the orientation of the heliostats until the real location pixel of the references corresponds to a specific pixel of the images or by varying the orientation of the heliostat according to some known set-points, based on the kinematic relation that is in effect and the reference searched.

The searches are carried out according to the references being previously selected or according to an outwards spiral motion. Carrying out the search once, offset value for the actuators is updated. Carrying out the search at least twice visualizing one or more of the references orientation of the heliostats is varied for each of the captures. Carrying out the search at least three times, the new kinematic relation is completely determined.

For improving accuracy of the heliostat more than one of the artificial vision devices can be arranged in a fixed manner to each of the heliostats. Additionally, each of the artificial vision devices is arranged in a fixed manner to a facet of the heliostat.

### DETAILED DESCRIPTION OF THE INVENTION

Present invention relates to a calibration method for heliostats that maximises efficiency of heliostat fields that include at least a solar receiver with precisely known location. The present invention allows the calibration of a high number (e.g. thousand or tens of thousand) of the heliostats included in the heliostat fields simultaneously. Said number is unlimited because all the heliostats of the heliostat field can be calibrated simultaneously because the calibration of each of the heliostats is independent from the calibration of the rest of the heliostats. The calibration method can be applied in parallel to all the heliostats of the heliostat field.

A calibration system for the heliostats comprises a set of said heliostats, a control means and a set of artificial vision devices. Each of the heliostats comprises a reflective element, which in turn comprises at least one facet. Additionally, each of the heliostats has one of the artificial vision devices arranged in a fixed manner such that the artificial vision devices are moved or displaced together with the reflective elements and in a same way. The reflective elements have a reflective side and a non-reflective side, the reflective side being the side from which reflection of sunlight exits the reflective elements. The reflective elements are configured for reflecting the sunlight to the solar receiver and can be planar or non-planar, for example comprising some of the facets angled between them or the reflective elements being curved with a concave shape. Additionally, the arrangement of the artificial vision devices on the heliostats is free; this is, it can be at any point of the heliostats with respect to geometric centre points of the reflective elements.

The artificial vision devices are configured for visualizing, recognizing and capturing references, which are described below. The artificial vision devices can visualize more than one of the references simultaneously, but this is not necessary in order to carry out the method. The artificial vision devices can visualize the references one by one in order to carry out the method. The artificial vision devices comprise, in a preferred manner, low-cost cameras and/or of a small size. Requirements of the artificial vision devices employed in the present invention allow these facts. For example, the artificial vision devices can comprise lenses limited to cover a narrow field of view because the artificial vision devices can be employed only to visualize, recognize and capture the references and in an individual fashion. Additionally, the artificial vision devices can be of the type included in mobile phones. This is possible because they also preferably comprise sensors commonly considered of low quality.

According to a preferred embodiment, the artificial vision devices are arranged at a rear part of the heliostats, this is at back face of the reflective elements in which the non-reflective side is located. The artificial vision devices are arranged focusing backwardly or laterally with respect to the corresponding heliostat for the visualization, recognition and capture of the references. This arrangement allows said artificial vision devices to be prevented from a direct exposure to solar radiation, and therefore from its potential negative effect on lifetime of the artificial vision devices, by the reflective elements. Furthermore, this arrangement of the artificial vision devices results in the allocation of entire area of the reflective surface to reflect the sunlight or the solar radiation to the solar receiver.

According to another preferred embodiment, the artificial vision devices are arranged at a front part of the heliostats, this is at front face of the reflective elements in which the reflective side is located. In this case, the artificial vision devices are arranged focusing forwardly or laterally with respect to the corresponding heliostat. Due to the small size of the artificial vision devices, reduction of the area of the reflective surfaces allocated to reflecting the solar radiation is very minor.

According to a further preferred embodiment, the artificial vision devices are arranged between the front face and the back face of the reflective elements, the reflective surfaces being planar or non-planar. In this case, the artificial vision devices are arranged focusing forwardly, laterally or backwardly. The artificial vision devices are arranged integrated in the reflective elements, they being inserted fully or partially into the reflective elements, for instance by means of perforations or they being located at spaces between the facets.

According to another further preferred embodiment, the artificial vision devices are arranged at a lateral part of the heliostats, this is at a lateral side of the reflective element, and focusing forwardly, backwardly or laterally with respect to the corresponding heliostat. In this way, the artificial vision devices do not reduce the area of the reflective surfaces. Preferably, at least part of the reflective element is placed between the sun and the artificial vision devices such that the artificial vision devices, and more particularly their sensors and/or their lenses, are prevented from the direct exposure to the solar radiation.

In the present invention, the artificial vision devices focus in any direction with respect to a central normal vector of the reflective element, and more specifically of the reflective side. In other words, focusing direction of the artificial vision devices can be according to a direction other than direction of the central normal vectors of the reflective sides. The central normal vectors start from the geometric centre points of both the planar and the non-planar reflective sides.

The references are disposed at any height with respect to the heliostats, this is on the ground or at elevated positions with respect to the heliostats and geographically distributed throughout or around the heliostat field. The references are disposed so that they are in field of vision of the artificial vision devices. Locations of the references are precisely known at any time during the calibration method in 3D environment in which are distributed.

Each of said references comprises identifying characteristics for being visualized, recognised and captured unequivocally by the calibration system by means of the artificial vision devices and the control means. The references can be natural, such as celestial bodies, or artificial.

The natural references are preferably selected from stars, the sun and the moon. The natural references are natural light sources that emit a natural light. The identifying characteristics of the natural references are determined according to this natural light. Preferably, the identifying characteristics are based on shape of the natural light. Additionally or alternatively, the identifying characteristics can be based on size, colour and/or intensity of said natural light.

The artificial references comprise an identifying element by means of which they comprise the identifying characteristics. In case of the references being artificial, the identifying characteristics are preferably based on the shape of the identifying element. Additionally or alternatively, the identifying characteristics can be based on to the size, colour, brightness, etc. of the identifying element of said artificial references.

The identifying element is preferably an artificial light emitted by the artificial references. Said artificial light can also be turned on and off for being visualized, recognised and captured unequivocally by the calibration system. Additionally or alternatively, it is a continuous or flashing light and/or of specific intensities for the same purpose.

Alternatively, the identifying element is an object configured such that each of the references can be visualized, recognised and captured unequivocally by the calibration system by means of the artificial vision devices and the control means. The objects can comprise codified elements for said purpose. These objects can be panels disposed only for acting as the references or any other element located in the heliostat field and which, besides acting as one of the references, plays another role in the heliostat field.

In accordance with what has been described, the references are also mobile or stationary. In both cases, their location is precisely or accurately known during the calibration method. For this, means such as GPS locators, laser tracking systems or photogrammetry are employed. In this way, the mobile references can be devices such as drones, flying or not flying.

Orientation of the heliostats is changed or varied by means of the control means, which defines set-points of actuators for orienting the heliostats. In other words, the orientation of the heliostats is changed or varied changing or varying the set-points of the actuators. Depending on kinematic chain of the heliostats, the set-points can be angular positions, linear displacements, etc. In the present invention, the heliostats are not limited to any type or any configuration.

In order to visualize the references by the artificial vision devices in the 3D environment, a search is carried out. For carrying out the search, the orientation of the heliostats is varied for visualizing and recognizing the references, the references being previously selected or determined. In this way, the variation in the orientation of the heliostats is done according to the known location of the references. If after said variation in the orientation of the heliostats the references previously selected or determined are not visualized, the orientation of the heliostats is again varied for instance according to an outwards spiral motion until said references are visualized and recognized.

After the search, and by means of the control means, a capture of the corresponding reference takes place. Said captures comprise a taking of an image visualised by the artificial vision device in which the reference searched appears, as well as a reading of value of sensors determining position of the actuators. The control means are also configured for collecting or storing data pertaining to said takings and said readings for later processing.

In said images in which the references appear, the natural light sources and the identifying elements can appear with a non-circular outer contour. This can be for example because the references are natural or because the identifying elements are not of a spherical shape. Additionally, despite having a circular external contour, when the identifying elements and the natural lights are focused with an angle with respect to their front, i.e. not frontally, they appear with the non-circular outer contour, such as an ellipse.

For the capture of the references, according to the image in 2D of the 3D environment in which they are located, the control means preferably detect the outer contour of the references; this is, the control means detects the outer contour of the natural lights and the identifying elements. After said detection, the control means fits a shape along said contour. A pixel, which is defined as location pixel, is then determined by the control means for said shape in the image taken in the corresponding capture. The location pixel in the images represents the known location of the references in the 3D environment. Said location pixel corresponds to any pixel of said shape, as for example central or midpoint pixel of said shape.

The control means determine the location of the references in the images taken according to their location pixel. This fact provides a high accuracy in calculations carried out by the method.

By way of examples, when the identifying elements are focused not frontally by the artificial vision devices, the outer contour of the identifying elements with a spherical shape appears as a circle in the images and the outer contour of the identifying elements with a circular shape appears as an ellipse. In these cases, the control means determine the location pixel of the circle and the ellipse that appear in the images.

When the location pixel of the references is determined, the location for the references is stablished in the images through one of the pixels, which is defined as a real location pixel.

As it has been described, the references are unequivocally recognized by their identifying characteristics, but in case of more than one of the references comprises the same identifying characteristics or just to confirm that the reference visualized is the reference that has been searched, an additional step is carried out according to the precisely known location of each of the references. After the visualization of one of the references and the recognition of the identifying characteristics of said reference, it is confirmed that the identifying characteristics correspond to the identifying characteristics of the reference located where the corresponding artificial vision device is focusing to. This confirmation is done by means of the control means.

According to a preferred embodiment, the search of the references involves changing the orientation of the heliostats until the real location pixel of the references corresponds to a specific pixel of the images visualized and taken. The specific pixel is previously defined or selected by the control means. Said specific pixel corresponds to any pixel of the images taken, as for example central or midpoint pixel of said images.

For this specific pixel, the control means define the set-points for the position of the actuators according to a kinematic relation that is in effect for the heliostats when the method is applied, which are defined as expected values of the sensors determining the position of the actuators. This kinematic relation can be for example an initial kinematic relation stablished upon the heliostats being installed.

Starting from these values, the heliostat focus the reference searched by means of its artificial vision device, so that the orientation of the heliostat is changed until the real location pixel of said reference corresponds to the specific pixel. Thus the heliostat is oriented in the required direction. The reading of the corresponding values of the sensors defining the positions of the actuators, which are defined as real values of the sensors defining the position of the actuators, is then collected and stored in the control means together with the expected values.

After this, an error is stablished or calculated. The error is established by the control means based on a difference between the real values of the sensors defining the position of the actuators and the expected values of the sensors determining the position of the actuators. According to this error the control means determine if the location of the heliostat in the heliostat fields and the kinematic relation that is in effect for said heliostat are correct for adequately reflecting the sunlight towards the solar receiver.

For this preferred embodiment, a set of the references can be captured according to a set of the specific pixels, this is varying the heliostat orientation for each specific pixel. In this method, for each of the specific pixels of the set the error is established independently. In other words each of the errors is determined as described above each time with the specific pixel being different.

The control means determine or identify a new kinematic relation for the heliostat according to a mathematical minimization process, which is known in the state of the art, of said errors established independently for each of the differences between the real and the expected values. This new kinematic relation will be the kinematic relation that is in effect when the calibration method is applied again.

The kinematic relation that is in effect for the heliostat implemented in the control means are replaced by the new kinematic relation to be used further on. This replacement supposes an update of the kinematic relation. At the same time, said update supposes the calibration of the heliostats. The update assures that the sunlight is reflected towards the solar receiver during the hours of sun.

An advantage of this preferred embodiment is that the artificial vision devices do not need to be calibrated, i.e. internal parameters of the artificial vision devices like distortion does not need to be known.

According to another preferred embodiment, the search is carried out by varying the orientation of the heliostat according to some known set-points, based on the kinematic relation that is in effect and the reference searched. If after this search said reference is not visualized, the orientation of the heliostat is again varied according to for instance the outwards spiral motion until said reference is visualized.

In this way, the search of the reference is carried out until the reference is visualized at any position within the image; that is at a non-specific or arbitrary pixel.

After the search of the references is carried out, the capture of the references takes place. In the image taken by the artificial vision devices the real location pixel of the references is stablished. Additionally, the real values of the sensors defining the position of the actuators are collected and stored.

Based on the kinematic relation that is in effect, the value of the sensors defining the position of the actuators correspond to an expected orientation. Therefore, for a particular value of the sensors, one of the references is expected to appear at a particular pixel of the image defined as expected location pixel. In the same way, if one of the references is identified in the image at a particular pixel a corresponding value of the sensors is expected. This value of the sensors are defined as the expected values of the sensors.

The control means use the real location pixel to calculate the expected value of the sensors defining the position of the actuators. As it has been said, this value of the sensors are at which the reference would be imaged at the real location pixel according to the kinematic relation that is in effect.

Then, the real value of the sensors and the expected value of the sensors are compared, and the error according to the difference between both is calculated. This is equivalent to using the distance between the real location pixel and the expected location pixel where the expected location pixel is estimated according to the kinematic relation that is in effect and projective properties of the corresponding artificial vision device.

If the real values of the sensors and the expected values of the sensors are the same, the error is null and therefore, there is no need of carrying out the calibration of the corresponding heliostat. But, if the real values of the sensor and the expected values of the sensor are different, the control means stablish the error. Therefore, for this preferred embodiment the errors are stablished or calculated according to differences between the real values of the sensor and the expected values of the sensors for the reference that has been captured.

In this way, the control means determine the new kinematic relation according to the mathematical minimization process of all the errors to adequately reflect the sunlight towards the solar receiver throughout the day as the errors are stablished for each of the orientations or the captures. The new kinematic relation that results is stablished such that the errors are minimized, preferably so they are null or nearly null, causing that the sunlight is adequately reflected towards the solar receiver by the corresponding heliostat.

In the present calibration method, in order to establish said new kinematic relation, the orientation of the heliostats is varied during the capturing of the references as many times as complexity of the kinematic relation that is in effect requires. That is for the kinematic relation that is in effect defined by a larger number of parameters of the heliostats (like for instance more complex axes configurations) more of the captures are needed in order to estimate all said parameters. Alternatively, a reduced number of the orientations can be used if only a reduced number of the parameters has to be estimated or verified and others are considered as known.

As an example, using one of the captures, a particular orientation of the corresponding heliostat can be fixed and therefore, a reference angle can be stablished for azimuth and elevation axes for the heliostat having such a configuration, providing that orientation of said axes is considered as known. This process do not imply identifying the kinematic relation completely but updating an offset value for the actuators, or at least for said axes. Using more than one of the captures, more than one of the reference angles can be defined and thus the sensors to be used can be cheaper since their measurements can be corrected at said particular orientations improving the accuracy of the heliostat. This can also avoid some hardware in each of the heliostats, like reference switches or homing switches, since these elements are installed to define the reference angles. All this leads to a cost reduction of the heliostats.

In the present calibration method, if the artificial vision devices are calibrated, the calibration method can use one of the references for more that one of the captures if the pixel of the image at which is visualized is varied for each of the captures. In this way, one of the references can be captured the orientation of the heliostats being varied for each of the captures. Therefore, the calibration method can be performed with only one of the references. This is, by variation of the orientation of the heliostats the reference is moved in the image and the pixel that corresponds to the real location pixel of the reference is varied in the image.

In the method, for each of the captures the real values of the sensors defining the positions of the actuators and their expected values according to the kinematic relation that is in effect are stored by the control means. The error is established by the control means based on the difference between the real and expected values of the sensors.

In a combinable manner more than one of the references captured at one or multiple pixels of the images corresponding to different orientations of the heliostats, can be used.

In a preferable way the captures of one of the references involves varying the orientation of the heliostats as large as possible. The real location pixels are equally distributed over all the images; that is not clustered in one part of the images. Thereby, the variation of the real value of sensors is maximized, thus reducing the influence of uncertainties in the positions of the actuators. As an example, said distribution can be done determining the real location pixel of the corresponding reference at or around a corner of the image different for each of the captures.

In the calibration method, the focusing directions of the artificial vision devices and that of the central normal vectors, are preferably known. Therefore, it is also known relation between the focusing direction of the artificial vision device and that of the central normal vector for each of the heliostats. As the artificial vision devices are arranged in the heliostats such that the artificial vision devices are moved or displaced together with the reflective elements and in the same way, and the central normal vector is fixed for the reflective element, this relation only has to be determined once. This relation can be determined during manufacturing process.

This relation is an important factor to allow the adequate reflection of the solar radiation towards the solar receiver. Therefore, if this relation is unknown, it has to be determined by an additional step. Preferably, said additional step is performed after the method, that is once the new kinematic relation for the heliostats is established.

For this additional step at least one further artificial vision device is required. This further artificial vision device comprises a camera of high quality independent from the heliostats, this is not attached to any of the heliostats. Preferably, said further artificial vision device is arranged in an elevated position with respect to the heliostats. For example, the further artificial vision device is arranged on a central receiver tower comprised in the heliostat field. The location of the further artificial vision device is precisely known in the 3D environment as happens with the location of the references.

By means of the further artificial vision device the reflection of one of the references is visualized in the reflective element of the heliostats for which described relation is to be determined. By means of said further artificial vision device the reflection of one of the references can be visualized in the reflective element of more than one of the heliostats. This allows establishing said relation for one or more of the heliostats at the same time.

While visualizing the reflection of the references with the further artificial vision device, by means of the known location of the references, the known location of said further artificial vision device and the new kinematic relation stablished, the focusing direction of the central normal vector and, therefore, the orientation of the heliostats is constrained to a unique orientation. This unique orientation for each of the heliostats is determined as a bisector between a vector from the further artificial vision device to the reflective surface and a vector from the reference reflected to the reflective surface.

The calibration method can be carried out during the hours of sunshine, at night or in a combined manner. Preferably, the calibration method is carried out at night because in this way the hours of sunshine can be entirely dedicated to reflect the sunlight to the solar receiver. Therefore, the efficiency of the heliostat field is maximized.

If it is necessary, the control means, which manage and coordinate all the operations, information and elements involved in the present calibration method, is also configured to correct inherent optical distortions of the images taken by means of the lenses of the artificial vision devices. Additionally, the control means are further configured to perform appropriate mathematical calculations for required conversion from the 3D environment to the image, which is 2D.

1. A calibration method for heliostats comprising a reflective element and having actuators, sensors defining position of the actuators and a kinematic relation that is in effect for the heliostats, characterized in that the method comprises the steps of:
carrying out at least a search to visualize at least a reference with a known location by means of an artificial vision device arranged in a fixed manner to each of the heliostats to be calibrated, such that the artificial vision devices are displaced together with the reflective elements and in a same way;
recognizing the reference searched;
carrying out a capture of the reference for each of the searches, the capture comprising a taking of an image visualized by the artificial vision device in which the reference appears and a reading of the value of the sensors;
collecting and storing data of the taking and the reading;
comparing the value of the sensors of the capture with the value of the sensors according to the kinematic relation that is in effect;
stablishing an error for each of the captures according to differences between the value of the sensors of the capture and the value of the sensors according to the kinematic relation that is in effect; and
determining a new kinematic relation that minimises the errors.

2. The calibration method according to claim 1, wherein the artificial vision devices are arranged at back face of the reflective element, at front face of the reflective element, between the back face and the front face of the reflective element or at a lateral side of the reflective element.

3. The calibration method according to claim 1, wherein the references comprise identifying characteristics for being visualized, recognized and captured unequivocally.

4. The calibration method according to claim 1, wherein the location of the references is determined according to a pixel contained in a shape fitted along outer contour of the identifying characteristics.

5. The calibration method according to claim 1, wherein the references are natural or artificial.

6. The calibration method according to claim 1, wherein the references are mobile or stationary.

7. The calibration method according to claim 1, wherein the searches are carried out according to the references being previously selected or according to an outwards spiral motion.

8. The calibration method according to claim 1, wherein by means of a further artificial vision device with a precisely known location reflection of one of the references is visualized in the reflective element of at least one of the heliostats, and a bisector between a vector from the further artificial vision device to the reflective element and a vector from the reference reflected to the reflective element is determined and comprises stablishing a relation between the bisector and focusing direction of the artificial vision devices.

9. The calibration method according to claim 1, wherein the searches of the references are carried out by changing the orientation of the heliostats until the real location pixel of the references corresponds to a specific pixel of the images.

10. The calibration method according to claim 1, wherein the searches of the references are carried out by varying the orientation of the heliostat according to some known set-points, based on the kinematic relation that is in effect and the reference searched.

11. The calibration method according to claim 1, wherein the search is carried out at least twice visualizing one or more of the references orientation of the heliostats being varied for each of the captures.

12. The calibration method according to claim 1, wherein carrying out the search once, offset value for the actuators is updated.

13. The calibration method according to claim 1, wherein carrying out the search at least three times, the new kinematic relation is completely determined.

14. The calibration method according to claim 1, wherein more than one of the artificial vision devices is arranged in a fixed manner to each of the heliostats.

15. The calibration method according to claim 14, wherein each of the artificial vision devices is arranged in a fixed manner to a facet of the heliostat.
